(19) United States
(12) Patent Application Publication
(10) Pub. No.: US 2014/0056638 A1
(43) Pub. Date: Feb. 27, 2014

(54) PIVOT JOINT FOR A STROLLER FRAME

(71) Applicant: LERADO (ZHONG SHAN) INDUSTRIAL CO., LTD., ZHONG SHAN CITY (CN)

(72) Inventors: TSE-CHIEN WU, KAOHSIUNG CITY (TW); JIA-HONG SU, YUNLIN COUNTY (TW); HSIN-FU CHENG, CHIAYI CITY (TW); YI-WEN WANG, CHIAYI COUNTY (TW)

(73) Assignee: LERADO (ZHONG SHAN) INDUSTRIAL CO., LTD., ZHONG SHAN CITY (CN)

(21) Appl. No.: 13/972,211

(22) Filed: Aug. 21, 2013

(30) Foreign Application Priority Data
Aug. 22, 2012 (CN) 201220418190.5

(51) Int. Cl. B62B 7/06

(52) U.S. Cl. CPC B62B 7/06
USPC 403/84

(57) ABSTRACT

A pivot joint for lockably and releasably connecting two members of a stroller frame includes a pivot joint, a locking mechanism and a release mechanism. The pivot joint has an upper joint part and a lower pivot part pivoted with each other. The lower pivot part is featured by comprising a first plate formed with a first engagable portion and a downward extension formed with a second engagable portion. The locking mechanism is connected between the stroller frame and the pivot joint for locking the stroller frame in an in-use configuration by simultaneously engaging with the first engagable portion and the second engagable portion. The release mechanism is operatively mounted on the stroller frame for disengaging the locking mechanism from the first engagable portion and the second engagable portion at the same time.

### BACKGROUND OF THE INVENTION

1. Field of the Invention

The present invention related to a pivot joint for pivot two members of a stroller frame, especially to a pivot joint having two engagable portions to lock the stroller frame in an in-use configuration.

2. Description of the Related Art

Pivot joint is used to pivot the push bar and the front strut of a foldable stroller. By locking the pivot joint, the stroller can be kept in an in-use configuration. When the pivot joint is unlocked, the stroller is permitted to be folded in a compact configuration.

Traditional pivot joint for stroller frame has only one engagable portion inside for locking itself, the structure is weakened. Once the stroller is hit on an obstacle, or the user wants to level up the front wheels over an obstacle, the pivot joint may be broken and cause the stroller to fold in a sudden, and then endanger the little occupant in the stroller.

### SUMMARY OF THE INVENTION

For improvement of the pivot joint and make it with a sturdy structure, the present invention provides a pivot joint for use in a stroller frame, includes a pivot joint 2, a locking mechanism 3 and a release mechanism 4. The pivot joint 2 has an upper joint part 22 and a lower pivot part 26 pivoted with each other. The lower pivot part 26 is featured by comprising a first plate 28 formed with a first engagable portion 30 and a downward extension 27 formed with a second engagable portion 40.

The locking mechanism 3 connects between the stroller frame 10 and the pivot joint 2 for locking the stroller frame 10 in an in-use configuration 100 by simultaneously engaging with the first engagable portion 30 and the second engagable portion 40.

The release mechanism 4 is operatively mounted on the stroller frame 10 for disengaging the locking mechanism 3 from the first engagable portion 30 and the second engagable portion 40 at the same time.

By this way, the pivot joint according to the present invention shall have two engaging points for enhancing the sturdiness of the pivot joint in the locking position.

### BRIEF DESCRIPTION OF THE DRAWINGS

The accompanying drawings, which are included to provide a further understanding of the invention are incorporated in and constitute a part of this specification, illustrate embodiments of the invention and together with the description serve to explain the principles of the invention. In the drawings:

FIG. 1 is a side view showing a pivot joint connecting two members of a stroller frame thereby locking the stroller frame in an in-use position.

FIG. 2 is an exploded view of one embodiment of the pivot joint according to the present invention.

FIG. 3 is a schematic cross-sectional view showing the pivot joint in a locked condition as the first latch element and the second latch element have been engaged with the first engagable portion and the second engagable portion at the same time.

FIG. 4 is a schematic cross-sectional view showing the pivot joint in an unlocked condition as the first latch element and the second latch element have been pulled to disengage from the first engagable portion and the second engagable portion at the same time.

FIG. 5 is a schematic cross-sectional view showing the pivot joint in an unlocked and foldable condition, the second latch element being slidably abutting on the peripheral of the first plate of the lower pivot part.

FIG. 6 is a schematic cross-sectional view showing the peripheral of the first plate of the lower pivot part may be formed with an indent for engaging with the second latch element thereby locking the pivot joint in a folded position.

### DETAILED DESCRIPTION OF THE PREFERRED EMBODIMENTS

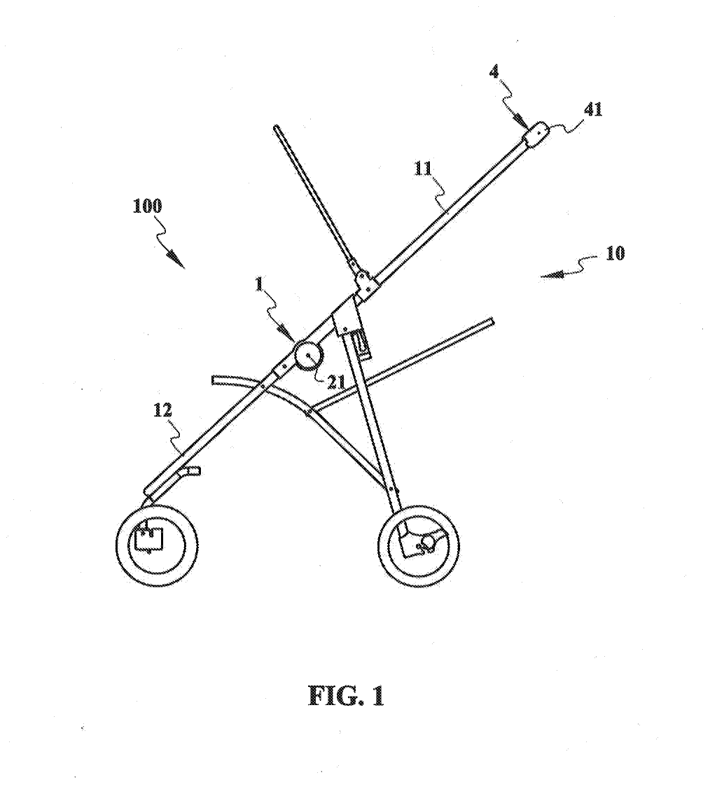

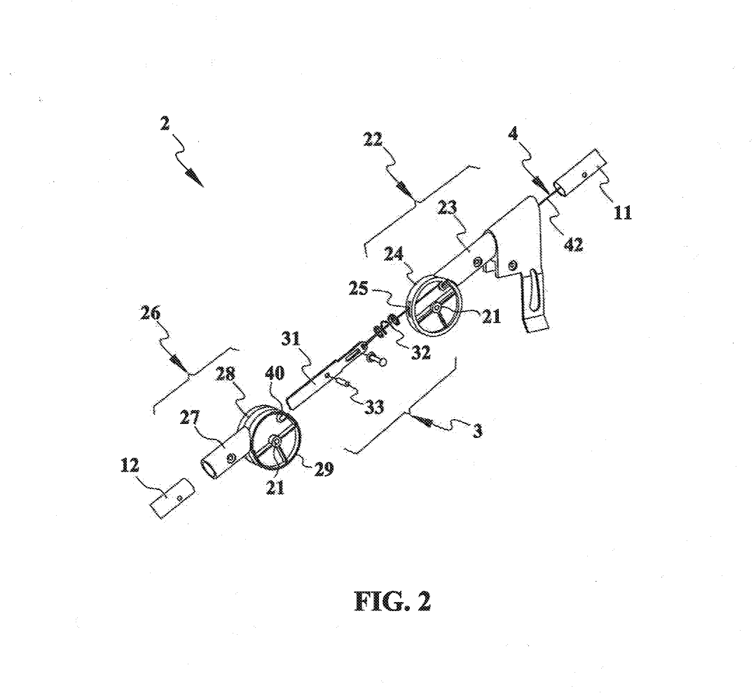

Referring to FIGS. 1 and 2, an embodiment of the pivot joint 2 for a stroller frame 10 according to the present invention, includes a pivot joint 2, a locking mechanism 3 and a release mechanism 4. The pivot joint 2 is adapted to connect the push bar 11 and the front strut 12 of the stroller frame 10 at a pivot point 1, and the locking mechanism 3 is capable of locking the push bar 11 and the front strut 12 in a straight configuration by engaging with the first engagable portion 30 and the second engagable portion 40 at the same time.

The pivot joint 2 has an upper joint part 22 and a lower pivot part 26 pivoted with each other. The lower pivot part 26 is featured by comprising a first plate 28 formed with a first engagable portion 30, and a downward extension 27 formed with a second engagable portion 40.

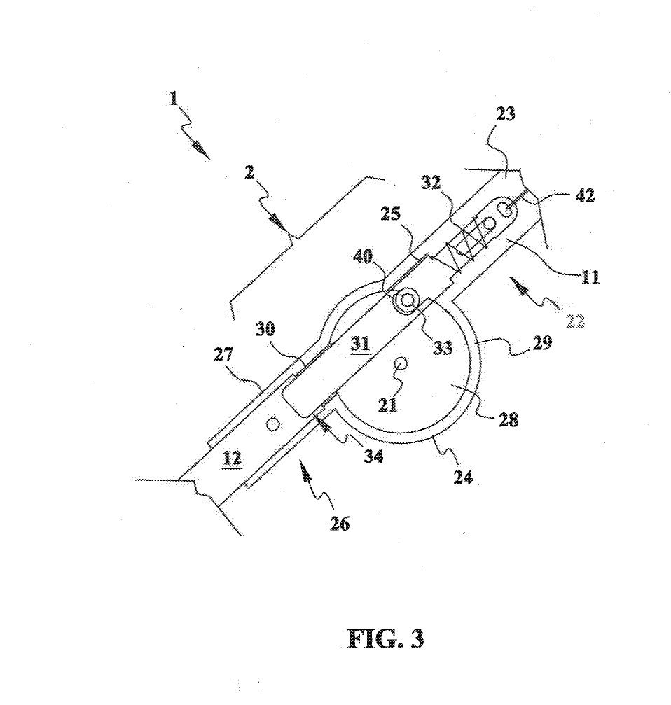

Referring to FIGS. 2 to 3, the first engagable portion 30 may either be either be embodied as an indent or a through hole formed in the downward extension 27 for engaging with the first latch element 31. The second engagable portion 40 may also be embodied as an indent formed on the peripheral of the first plate 28 for engaging with the second latch element 33.

The upper joint part 22 of the present invention includes a second plate 24 and an upward extension 23. The second plate 24 and the upward extension 23 may either be connected or formed integrally with each other. The upper joint part 22 is featured by having a through slot 25 formed in the second plate 24 and extended through the upward extension 23.

The locking mechanism 3 is connected between the stroller frame 10 and the pivot joint 2, and has one end retractably mounted in the through slot 25, so as to engage with the first engagable portion 30 and the second engagable portion 40 of the lower pivot part 26 thereby locking the stroller frame 10 in an in-use configuration 100 by simultaneously engaging with the first engagable portion 30 and the second engagable portion 40.

The locking mechanism 3 may include a first latch element 31 and a second latch element 33. The first latch element 31 is biased by a resilient element 32 and slidably and retractably mounted in the through slot 25. The first latch element 31 as a first position 34 to be engaged with the first engagable portion 30, and a second position 35 to be disengaged from the first engagable portion 30.

The second latch element 33 is connected with and protruded from the first latch element 31 and capable of engaging to and disengaging from the second engagable portion 40.

Both the first latch element 31 and the second latch element 33 are biased by the resilient element 32 for keeping the both to engage with the first engagable portion 30 and the second engagable portion 40 so as to lock the stroller frame 10 in the in-use configuration 100.

The release mechanism 4 is operatively mounted on the stroller frame 10 for disengaging the locking mechanism 3 from the first engagable portion 30 and the second engagable portion 40 at the same time. In this embodiment, the release mechanism 4 is associated with the first latch element 31 for pulling the first latch element 31 against the resilient element 32, so as to pull the first latch element 31 apart from the first position 34 to the second position 35 thereby disengaging the first latch element 31 and the second latch element 33 from the first engagable portion 30 and the second engagable portion 40.

Preferably, the release mechanism 4 may include a release actuator 41 and a connecting element 42. The release actuator 41 is operatively mounted on the stroller frame 10 and associated with the first latch element 31. The connecting element 42 is connected between the release actuator 41 and the first latch element 31. By operate the release actuator 41 on the push bar 11, a user is capable of unlocking the stroller frame 10 from the in-use configuration 100.

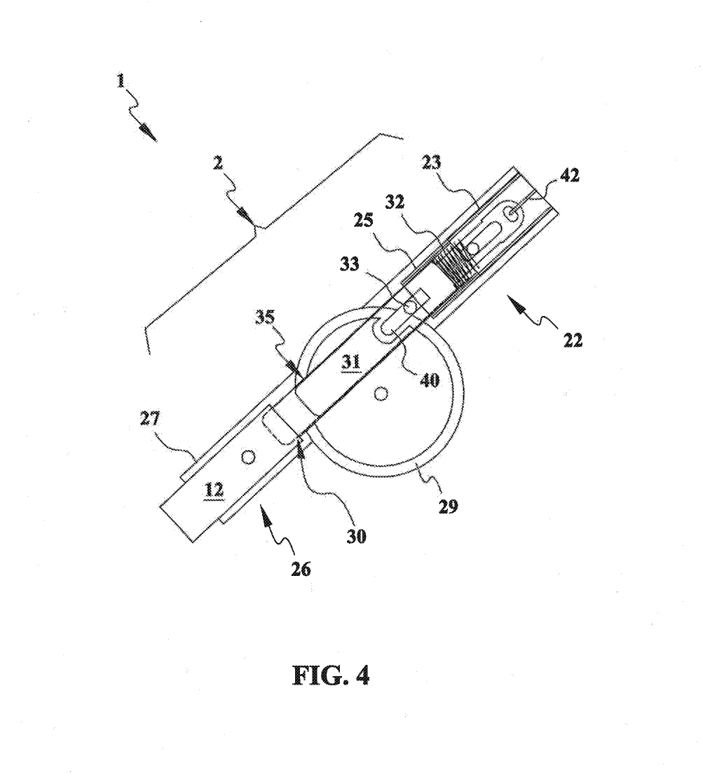

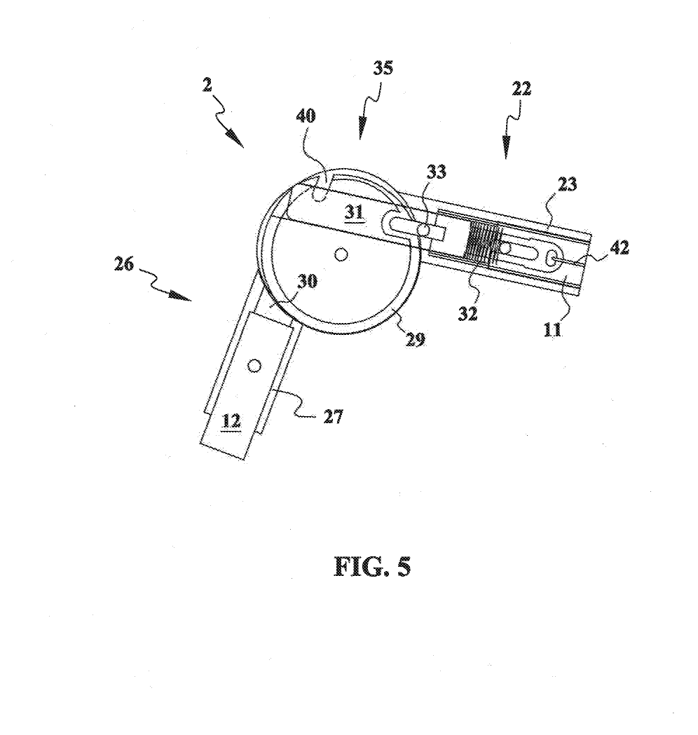

Referring to FIGS. 4 to 5, the second latch element 33 is arranged to slidably abut on the peripheral of the first plate 28 thereby keeping the first latch element 31 in the second position 35 while being folding the upper joint part 22 relative to the lower pivot part 26.

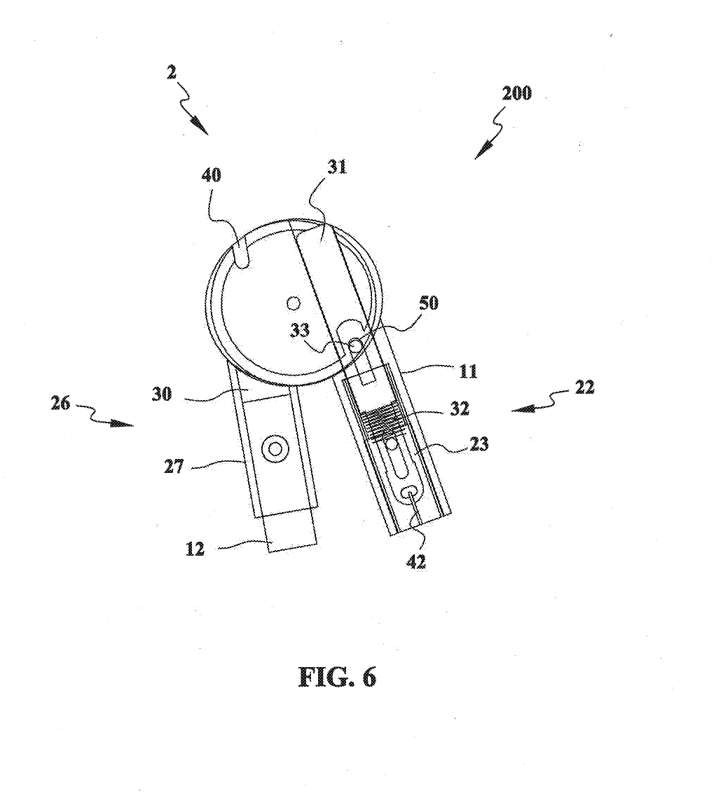

Referring to FIG. 6, it is also appreciated that the first plate 28 may further be formed with a notch 50 for engaging with the second latch element 33 thereby locking the pivot joint 2 in a folded position 200.

By the embodiment of this invention, the pivot joint 2 shall have two engaging points for enhancing the sturdiness of the same in using in a stroller frame.

While particular embodiments of the invention have been described, those skilled in the art will recognize that many modifications are possible that will achieve the same goals by substantially the same system, device or method, and where those systems, devices or methods still fall within the true spirit and scope of the invention disclosed.

What is claimed is:

1. A pivot joint for a stroller frame, capable of lockably and releasably connecting two members at a pivot point (1) of a stroller frame (10), including:
a pivot joint (2), having an upper joint part (22) and a lower pivot part (26) pivoted with each other; wherein the lower pivot part (26) is featured by comprising a first plate (28) formed with a first engagable portion (30) and a downward extension (27) formed with a second engagable portion (40);
a locking mechanism (3) connected between the stroller frame (10) and the pivot joint (2), for locking the stroller frame (10) in an in-use configuration (100) by simultaneously engaging with the first engagable portion (30) and the second engagable portion (40); and
a release mechanism (4) operatively mounted on the stroller frame (10) for disengaging the locking mechanism (3) from the first engagable portion (30) and the second engagable portion (40) simultaneously.

2. The pivot joint for a stroller frame according to claim 1, wherein the pivot joint (2) connects a push bar (11) and a front strut (12) at the pivot point (1), and the locking mechanism (3) is capable of locking the push bar (11) and the front strut (12) in a straight configuration by simultaneously engaging with the first engagable portion (30) and the second engagable portion (40).

3. The pivot joint for a stroller frame according to claim 1, wherein the upper joint part (22) has a second plate (24) and an upward extension (23), in which is featured by having a through slot (25) formed in the second plate (24) and extended through the upward extension (23), for one end of the locking mechanism (3) to be retractably mounted in the through slot (25), so as to engage with the first engagable portion (30) and the second engagable portion (40) of the lower pivot part (26).

4. The pivot joint for a stroller frame according to claim 1, wherein the locking mechanism (3) includes:
a first latch element (31), biased by a resilient element (32) and slidably and retractably mounted in the through slot (25), having a first position (34) to be engaged with the first engagable portion (30), and a second position (35) to be disengaged from the first engagable portion (30); and
a second latch element (33), connected with and protruded from the first latch clement (31) and capable of engaging to and disengaging from the second engagable portion (40);
wherein both the first latch element (31) and the second latch element (33) are biased by the resilient element (32) for keeping to engage with the first engagable portion (30) and the second engagable portion (40) thereby locking the stroller frame (10) in the in-use configuration (100).

5. The pivot joint for a stroller frame according to claim 4, wherein the release mechanism (4) is associated with the first latch element (31), for pulling the first latch clement (31) against the resilient element (32) thereby moving the first latch element (31) from the first position (34) to the second position (35), so as to disengage the first latch element (31) and the second latch element (33) from the first engagable portion (30) and the second engagable portion (40) thereby'unlocking the stroller frame (10) from the in-use configuration (100).

6. The pivot joint for a stroller frame according to claim 4, wherein the release mechanism (4) includes:
a release actuator (41) operatively mounted on the stroller frame (10) and associated with the first latch element (31); and
a connecting element (42) connected between the release actuator (41) and the first latch element (31).

7. The pivot joint for a stroller frame according to claim 4, wherein the second latch element (33) is slidably abutted on a peripheral of the first plate (28) thereby keeping the first latch element (31) in the second position (35).

8. The pivot joint for a stroller frame according to claim 4, wherein the second engagable portion (40) is an indent formed on a peripheral of the first plate (28) for engaging with the second latch element (33).

9. The pivot joint for a stroller frame according to claim 4, wherein the first engagable portion (30) is an indent formed in the downward extension (27) for engaging with the first latch element (31).

10. The pivot joint for a stroller frame according to claim 4, wherein the first engagable portion (30) is a through hole formed in the downward extension (27) for engaging with the first latch element (31).

11. The pivot joint for a stroller frame according to claim 4, wherein the first plate (28) is formed with a notch (50) for engaging with the second latch element (33) thereby locking the pivot joint (2) in a folded position (200).
